(19) United States
(12) Patent Application Publication
(10) Pub. No.: US 2026/0184282 A1
(43) Pub. Date: Jul. 2, 2026

(54) HYBRID AIRBAG INFLATOR

(71) Applicant: Joyson Safety Systems Acquisition LLC, Auburn Hills, MI (US)

(72) Inventors: Deborah Hordos, Troy, MI (US); Mariano Fontana, Lakeland, FL (US); Steve Parrish, Valrico, FL (US)

(21) Appl. No.: 19/430,511

(22) Filed: Dec. 23, 2025

Related U.S. Application Data
(60) Provisional application No. 63/739,941, filed on Dec. 30, 2024.

(51) Int. Cl. B60R 21/264; B60R 21/263

(52) U.S. Cl. CPC B60R 21/2644; B60R 21/263

(57) ABSTRACT

A hybrid airbag inflator includes a pyrotechnic booster gas generant disposed in a booster combustion chamber and a pyrotechnic main gas generant disposed in a main combustion chamber. The hybrid airbag inflator also includes an initiator and a pressurized gas. The pyrotechnic booster gas generant and the pyrotechnic main gas generant are the same pyrotechnic composition but take different physical forms. The initiator deploys into the booster combustion chamber to ignite the pyrotechnic booster gas generant which in turn ignites the pyrotechnic main gas generant. The pressurized gas is in fluid communication with both the booster combustion chamber and the main combustion chamber prior to deploying the initiator, such that the pyrotechnic booster gas generant in the booster combustion chamber is under pressure before the initiator deploys.

### CROSS-REFERENCE TO RELATED APPLICATIONS

This application claims the benefit of U.S. Provisional Patent Application No. 63/739,941 filed Dec. 30, 2024, the entire contents of which are incorporated by reference herein.

### TECHNICAL FIELD

The present disclosure relates to safety devices for passenger vehicles. In particular, the disclosure relates to a hybrid airbag inflator. Passenger vehicles may include, for example, automobiles, boats, trains, aircrafts, and spacecrafts.

### BACKGROUND

Airbags have been widely adopted in passenger vehicles, such as automobiles, for improving the safety of occupants. An inflator is operated by an ignition signal received from the vehicle when a vehicle sensor detects an emergency event, such as a collision, and inflates the airbag to a position between an occupant and a portion of the vehicle to cushion the occupant's momentum. The inflator is typically required to produce a sufficient amount of inflation gas to inflate the inflatable protection device in a very short period of time. In some inflators, pyrotechnic gas generants are used in combination with a pressurized gas to rapidly release the required inflation gas into the airbag.

These inflators, known as hybrid inflators (i.e., pyrotechnics and pressurized gas), provide many advantages, such as rapid inflation of the airbag with less heat and solid particulates. Some hybrid inflators comprise two or more pyrotechnic gas generants. These generants, however, are formed from different pyrotechnic compositions in order to serve different functions within the hybrid inflator. This adds complexity and cost to development and manufacturing. Therefore, there is a need for an improved hybrid inflator that can optimize airbag performance while minimizing complexity.

### SUMMARY

In various implementations, a hybrid airbag inflator comprises a pyrotechnic booster gas generant disposed in a booster combustion chamber, a pyrotechnic main gas generant disposed in a main combustion chamber, an initiator, and a pressurized gas. The pyrotechnic booster gas generant and the pyrotechnic main gas generant comprise the same pyrotechnic composition but different physical forms, the initiator deploys into the booster combustion chamber to ignite the pyrotechnic booster gas generant, and the pressurized gas is in fluid communication with both the booster combustion chamber and the main combustion chamber prior to deploying the initiator.

In some implementations, the pyrotechnic booster gas generant comprises the physical form of granules. In some implementations, the granules comprise granules larger than a U.S. #60 sieve size and smaller than a U.S. #4 sieve size. In some implementations, the granules comprise granules larger than a U.S. #40 sieve size and smaller than a U.S. #6 sieve size. In some implementations, the granules comprise granules larger than a U.S. #20 sieve size and smaller than a U.S. #8 sieve size.

In some implementations, the pyrotechnic main gas generant comprises the physical form of tablets.

In some implementations, the pressurized gas comprises a mixture of argon and helium. In some implementations, the mixture of argon and helium comprises 80% or more of argon by mole ratio and 20% or less helium by mole ratio. In other implementations, the mixture of argon and helium comprises 95% or more of argon by mole ratio and 5% or less helium by mole ratio.

In some implementations, the pressurized gas is pressurized to a range of 4500 to 5500 psi. In some implementations, the pressurized gas is pressurized to a range of 4750 to 5250 psi. In some implementations, the pressurized gas is pressurized to a range of 4900-5100 psi.

In various implementations, a method of reducing an output of a hybrid airbag inflator comprises installing, into a vehicle, a hybrid airbag inflator comprising a pyrotechnic booster gas generant disposed in a booster combustion chamber, a pyrotechnic main gas generant disposed in a main combustion chamber, an initiator, and a pressurized gas. The pyrotechnic booster gas generant and the pyrotechnic main gas generant comprise the same pyrotechnic composition but different physical forms and the pressurized gas is in fluid communication with both the booster combustion chamber and the main combustion chamber prior to deploying the initiator. The method also comprises sending a signal to the initiator to deploy the initiator into the booster combustion chamber to ignite the pyrotechnic booster gas generant.

In some implementations, the pyrotechnic booster gas generant comprises the physical form of granules. In some implementations, the pyrotechnic main gas generant comprises the physical form of tablets.

In some implementations, the pressurized gas comprises a mixture of argon and helium. In some implementations, the mixture of argon and helium comprises 95% or more of argon by mole ratio and 5% or less helium by mole ratio.

In some implementations, the pressurized gas is pressurized to a range of 4500 to 5500 psi. In some implementations, the pressurized gas is pressurized to a range of 4750 to 5250 psi. In some implementations, the pressurized gas is pressurized to a range of 4900-5100 psi.

### BRIEF DESCRIPTION OF THE DRAWINGS

The drawings are merely exemplary to illustrate steps, structure, and certain features that can be used singularly or in combination with other features. The disclosure should not be limited to the implementations shown.

FIG. 1 is a top-down view of a hybrid airbag inflator according to the present disclosure.

FIG. 2 is a perspective view of the hybrid airbag inflator of FIG. 1.

FIG. 3 is cross-sectional view of the hybrid airbag inflator of FIG. 1 taken through the plane A-A in FIG. 1.

FIG. 4 is another cross-sectional view of the hybrid airbag inflator of FIG. 1 taken through the plane B-B in FIG. 1.

FIG. 5 is a graph of pressure vs. time for the hybrid airbag inflator of FIG. 1.

FIG. 6 is a flow chart of method steps for implementing a method using the hybrid airbag inflator of FIG. 1.

### DETAILED DESCRIPTION

The present disclosure relates to safety devices for passenger vehicles. The devices, assemblies, systems, and methods disclosed herein provide for a hybrid airbag inflator comprising a pyrotechnic booster gas generant disposed in a booster combustion chamber and a pyrotechnic main gas generant disposed in a main combustion chamber. An initiator deploys into the booster combustion chamber to ignite the pyrotechnic booster gas generant. Byproducts of the combustion of the pyrotechnic booster gas generant, such as heat, gas, and molten solids, leave the booster combustion chamber and enter the main combustion chamber, thereby igniting the pyrotechnic main gas generant. The pyrotechnic booster gas generant and the pyrotechnic main gas generant comprise the same pyrotechnic composition but different physical forms (e.g., granules vs. tablets, discussed below). A pressurized gas is in fluid communication with both the booster combustion chamber and the main combustion chamber prior to deploying the initiator.

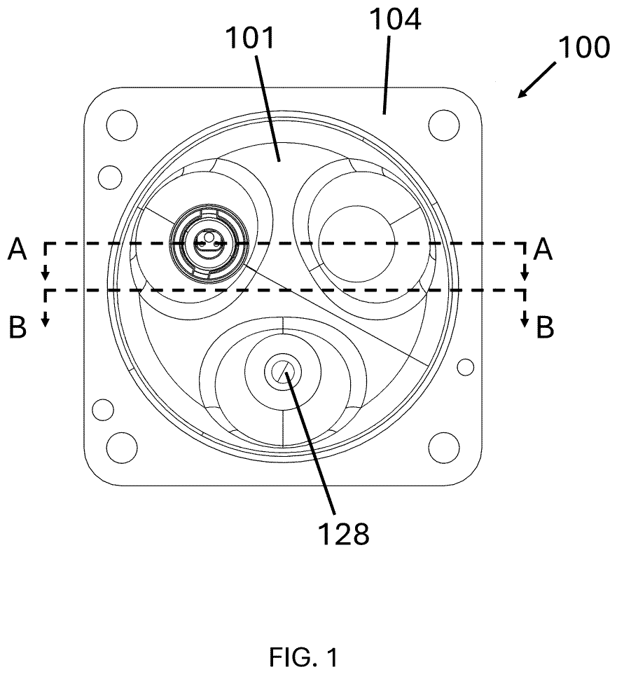

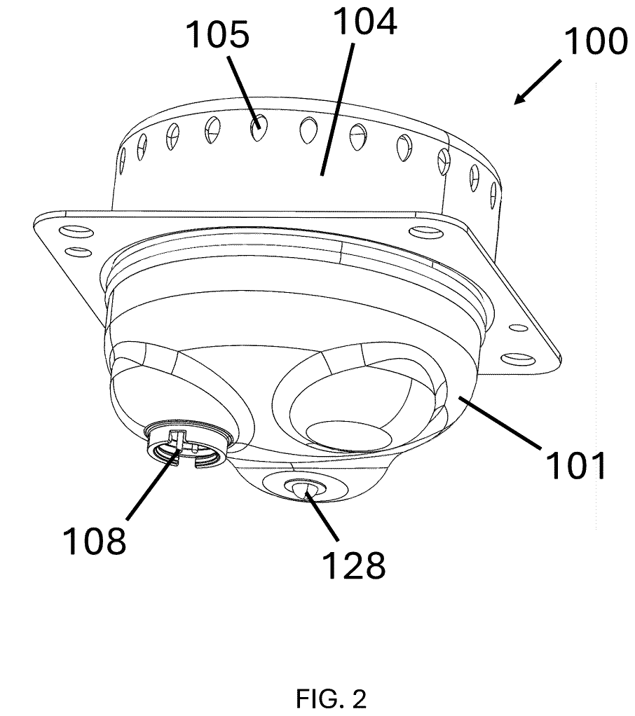

Referring now to FIGS. 1-4, a hybrid airbag inflator 100 comprises a base 101 and a cap 102. The base 101 and cap 102 are coupled together to seal the hybrid airbag inflator 100 at least partially from the outside environment. In some implementations, the base 101 and cap 102 are coupled together by welding (e.g., laser weld or friction weld). In other implementations, the base 101 and cap 102 may be coupled together by a threaded engagement or an adhesive. A diffuser 104 is coupled to the cap 102 and at least partially surrounds the cap 102. In some implementations, the cap 102 and diffuser 104 are coupled together by welding (e.g., laser weld or friction weld). In other implementations, the cap 102 and diffuser 104 may be coupled together by a threaded engagement or an adhesive. The diffuser 104 may define a flange for facilitating coupling of the hybrid airbag inflator 100 to a vehicle component, such as an airbag module.

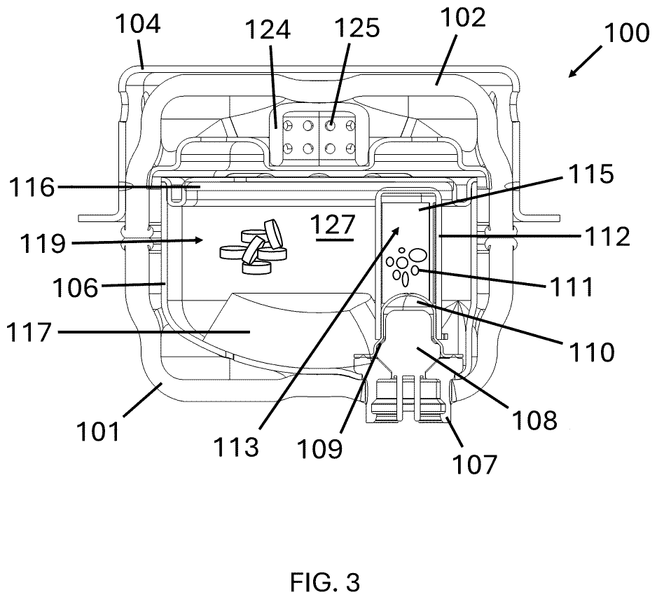

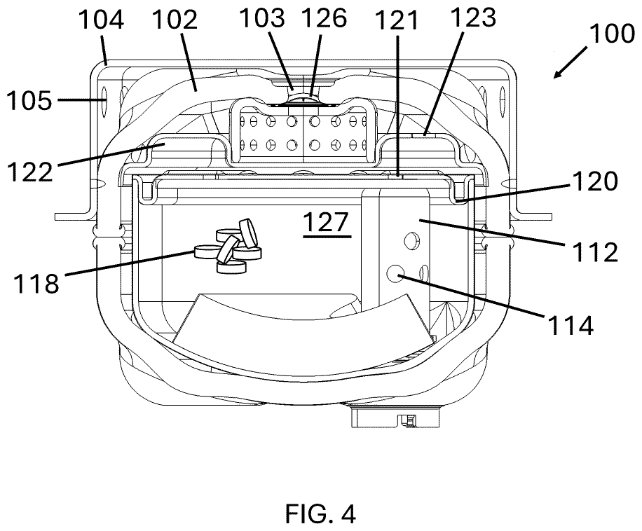

The base 101 and cap 102 define a cavity therebetween when coupled together, wherein multiple other inflator components may be disposed. As shown in FIGS. 3-4, the hybrid airbag inflator 100 further comprises a generant cup 106, a generant cup cap 120, a first cushion 116, and a second cushion 117. The generant cup cap 120 may be pressed onto an open end of the generant cup 106 such that an interference fit is formed, defining therebetween a main combustion chamber 119. The first cushion 116 and the second cushion 117 are disposed within the main combustion chamber 119, wherein the first cushion 116 abuts the generant cup cap 120 and the second cushion 117 abuts the generant cup 106 opposite the first cushion 116.

The base 101 defines an opening for receiving a bore seal 107 which seals the opening. The bore seal 107 extends at least partially into the main combustion chamber 119 and is welded to the base 101 such a portion of the generant cup 106 is clamped between the bore seal 107 and the base 101, as seen in FIG. 3, thus totally enclosing the main combustion chamber 119 (working in conjunction with the generant cup cap 120). An initiator 108 is crimped into the bore seal 107 and an initiator seal cap 110 is positioned over and around the initiator 108 and coupled (e.g., welded) to the bore seal 107. An o-ring 109 is positioned between the initiator 108 and the initiator seal cap 110 to seal the hybrid airbag inflator 100 from external contaminants.

A booster tube 112 is press-fit around the initiator seal cap 110 and extends further into the main combustion chamber 119. Therefore, a booster combustion chamber 113 is defined within the booster tube 112 and is bounded by the booster tube 112 and the initiator seal cap 110, as shown in FIG. 3. The booster tube 112 defines booster tube orifices 114 in a side wall of the booster tube 112 to allow fluid communication between the booster combustion chamber 113 and the main combustion chamber 119. A retainer 115 is inserted into the booster combustion chamber 113 and is sized and configured to retain a pyrotechnic booster gas generant 111 within the booster combustion chamber 113 and prevent physical movement of the pyrotechnic booster gas generant 111 through the booster tube orifices 114 and into the main combustion chamber 119. The retainer 115, however, has a smaller outer diameter than the inner diameter of the booster tube 112 such that the retainer 115 covers the booster tube orifices 114 but does not seal off fluid communication between the main combustion chamber 119 and the booster combustion chamber 113.

A pyrotechnic main gas generant 118 is disposed within the main combustion chamber 119 between the first cushion 116 and the second cushion 117. Only a small sample of the pyrotechnic main gas generant 118 is shown in FIGS. 3-4, however it should be understood that, preferably, the pyrotechnic main gas generant 118 fills a substantial portion of the volume of the main combustion chamber 119 around the booster tube 112 and in between the first cushion 116 and the second cushion 117, which both provide for protection of the main gas generant 118 against vibration and shock forces that may be imparted on the hybrid airbag inflator 100 during manufacturing, transportation, and final end use within a vehicle.

Disposed external of the main combustion chamber 119, but internal of the hybrid airbag inflator 100, is a first baffle 122 defining first baffle orifices 123 and a second baffle 124 defining second baffle orifices 125. The first baffle 122 is press fit around the generant cup cap 120 and the second baffle 124 is disposed between the first baffle 122 and the cap 102. The cap 102 defines a cap orifice 103 which is sealed with a burst disk 126. To facilitate fluid communication between the main combustion chamber 119 and the first baffle 122 and the second baffle 124, the generant cup cap 120 defines generant cup cap orifices 121.

A pressurized gas 127 is stored within the hybrid airbag inflator 100 such that the entirety of the internal volume of the cavity defined between the base 101 and the cap 102 is pressurized and occupied by the pressurized gas 127. Therefore, the pressurized gas 127 fills the main combustion chamber 119 and the booster combustion chamber 113 (since the retainer 115 does not seal off fluid communication with the booster combustion chamber 113) prior to deploying the initiator 108. The pressurized gas 127 may be injected into the hybrid airbag inflator 100 via an injection port defined by the base 101 and sealed by a gas fill ball 128, which is welded to the base 101 to seal the injection port during the injection process, as known in the art.

The pressurized gas 127 may comprise a mixture of argon and helium, for example. In some implementations, the mixture of argon and helium comprises 80% or more of argon by mole ratio and 20% or less helium by mole ratio. In other implementations, the mixture of argon and helium comprises 95% or more of argon by mole ratio and 5% or less helium by mole ratio. The pressurized gas 127 is pressurized to a range of 4500 to 5500 psi, more preferably to a range of 4750 to 5250 psi, and even more preferably to a range of 4900 to 5100 psi. For example, in some implementations the target pressure may be 5000 psi.

To actuate the hybrid airbag inflator 100, an electric signal may be sent to the initiator 108 (from a vehicle controller, for example) upon detection of a vehicle emergency event. The initiator 108 deploys through the initiator seal cap 110 and into the booster combustion chamber 113 to ignite the pyrotechnic booster gas generant 111. Byproducts of the combustion of the pyrotechnic booster gas generant 111, such as heat, gas, and molten solids, leave the booster combustion chamber 113 through the booster tube orifices 114 and enter the main combustion chamber 119, thereby igniting the pyrotechnic main gas generant 118. The combustion of the pyrotechnic booster gas generant 111 and pyrotechnic main gas generant 118 add heat and additional gas to the pressurized gas 127, thereby increasing the pressure within the hybrid airbag inflator 100, causing the burst disk 126 to rupture. The combustion byproducts and the pressurized gas 127 flow through the generant cup cap orifices 121, the first baffle orifices 123, the second baffle orifices 125, the cap orifice 103, and out the diffuser orifices 105 into the external environment which may, for example, include an airbag cushion.

In prior art inflators, typically the booster gas generant and main gas generant comprise different pyrotechnic compositions and different physical forms. The physical forms gas generants may take include, by way of non-limiting example, powder, granules, tablets, wafers, slugs, and extrudelets (i.e., the gas generant is extruded). These physical forms are well known in the art and the choice of physical form can impact the generant's characteristics such as ignitability and burn rate. For example, the more surface area that is available to propagate combustion, the faster a pyrotechnic will ignite and burn.

Different pyrotechnic compositions similarly provide for different characteristics, such as gas to solids combustion ratio, burn rate, ignitability, effluent gas composition, and pressure, all of which are important for tuning inflator performance. In prior art inflators, a booster gas generant would ideally produce high levels of heat, gas pressure, and flaming particulate matter in a very short period of time. This ensures improved ignitability and combustion efficiency of a main gas generant which tends to be harder to ignite and produce higher levels of gas and ideally no flaming particulate matter, while burning slower than the booster gas generant. Examples of pyrotechnic compositions for booster gas generants and main gas generants are disclosed in U.S. Pat. No. 10,214,460 (Appendix A) and U.S. Pat. No. 10,358,393 (Appendix B), respectively, both of which are incorporated herein by reference and filed herewith as part of this disclosure.

As disclosed herein, the pyrotechnic booster gas generant 111 and the pyrotechnic main gas generant 118 comprise the same pyrotechnic composition but different physical forms. For example, both the pyrotechnic booster gas generant 111 and the pyrotechnic main gas generant 118 may comprise the same pyrotechnic composition as selected from the compositions disclosed in Appendix B. Further, the pyrotechnic booster gas generant 111 may comprise the physical form of granules while the pyrotechnic main gas generant 118 may comprise the physical form of tablets, wherein the granules physical form will burn faster than the tablets physical form.

In some implementations, the granules comprise granules larger than a United States (U.S.) #60 sieve size and smaller than a U.S. #4 sieve size. In some implementations, the granules comprise granules larger than a U.S. #40 sieve size and smaller than a U.S. #6 sieve size. In some implementations, the granules comprise granules larger than a U.S. #20 sieve size and smaller than a U.S. #8 sieve size. In one specific example, the granules comprise granules larger than a U.S. #14 sieve size and smaller than a U.S. #8 sieve size. Standard U.S. sieve sizes are well known in the art to those having ordinary skill. In some implementations, the tablets are cylindrical in shape, and may include slightly domed end surfaces, having an approximate height of 2.20 mm and a diameter of 6.35 mm.

To enable the hybrid airbag inflator 100 to utilize a pyrotechnic composition traditional to main gas generants for both the pyrotechnic booster gas generant 111 and the pyrotechnic main gas generant 118 and achieve the necessary performance requirements of the hybrid airbag inflator 100, the pressurized gas 127 is in fluid communication with both the booster combustion chamber 113 and the main combustion chamber 119 prior to deploying the initiator, as discussed above. In other words, the entirety of both the pyrotechnic booster gas generant 111 and the pyrotechnic main gas generant 118 is under pressure before the deployment of the initiator 108. As a result, ignitibility and burn rate, for example, are improved due to the high-pressure environment which is conducive to such pyrotechnic characteristics. Therefore, the hybrid airbag inflator 100 can achieve the desired performance results using only a traditional main gas generant (i.e., no traditional booster gas generant).

As described above, in some implementations, the pressurized gas 127 is pressurized to a range of 4500 to 5500 psi. In some implementations, the pressurized gas 127 is pressurized to a range of 4750 to 5250 psi. In some implementations, the pressurized gas 127 is pressurized to a range of 4900-5100 psi. In one specific example, the pressurized gas 127 is pressurized to a target pressure of 5000 psi (i.e., due to tolerances, some plus/minus range around the target is unavoidable).

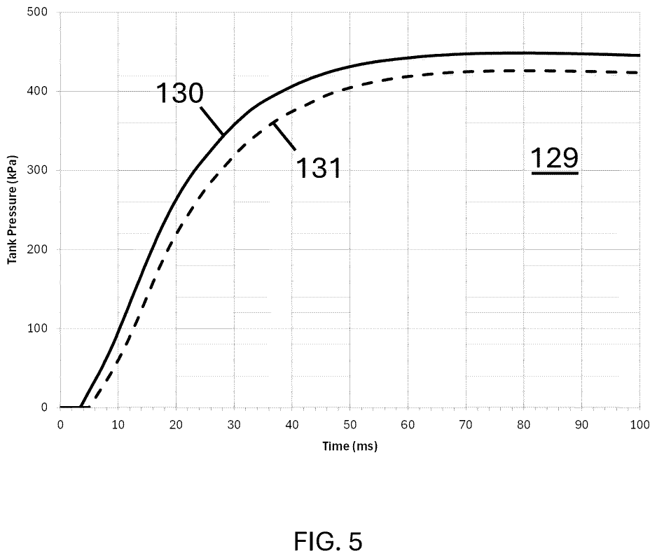

Under these pressures and using the same pyrotechnic composition but different physical forms, performance of the hybrid airbag inflator 100 can be tuned as desired, for example as shown in FIG. 5. FIG. 5 shows a graph 129 showing examples of a pressure output curve, in kPa, of a hybrid airbag inflator 100 versus time for a deployment in a sealed 60 L pressure vessel (i.e., tank pressure) equipped with pressure sensors. The 60L tank pressure test is a common and well understood test to persons having ordinary skill in the art. For example, the 60L tank test can be found in the USCAR Inflator Technical Requirements and Validation specification (USCAR-24 Revision 2, as published in April 2013, which can be found at https://www.sae.org/standards/content/uscar24).

As can be seen, pressure output curve 130 shows a traditional hybrid airbag inflator using a traditional booster gas generant and a traditional main gas generant. Pressure output curve 131 shows a hybrid airbag inflator 100 using the pyrotechnic booster gas generant 111 and the pyrotechnic main gas generant 118 comprising the same pyrotechnic composition but different physical forms, as disclosed herein. The pressure of the pressurized gas 127 is otherwise the same in both examples. As is clear, pressure output curve 131 exhibits a slower time to first gas (TTFG), a lower slope from TTFG to 20 ms (for example), and a lower peak pressure at approximately 80 ms. All of these factors are important for hybrid airbag inflator performance, and using a hybrid airbag inflator 100 can produce a more idealized pressure output curve than traditional hybrid airbag inflators. In other words, because traditional booster gas generants ignite and burn faster than traditional main gas generants, especially when under pressure, the hybrid airbag inflator 100 as disclosed herein may have its performance “softened” such that it is less aggressive but still able to satisfy all performance requirements.

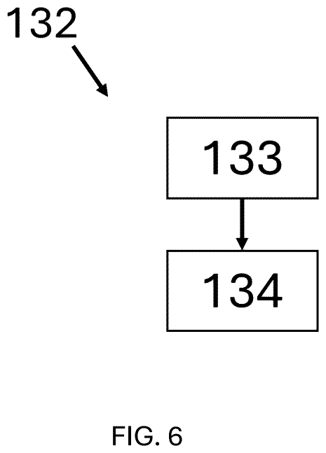

Referring now to FIG. 6, a process flow chart 132 shows steps for a method of reducing an output of a hybrid airbag inflator 100. Step 133 comprises installing, into a vehicle, a hybrid airbag inflator 100 comprising a pyrotechnic booster gas generant 111 disposed in a booster combustion chamber 113, a pyrotechnic main gas generant 118 disposed in a main combustion chamber 119, an initiator 108, and a pressurized gas 127. The pyrotechnic booster gas generant 111 and the pyrotechnic main gas generant 118 comprise the same pyrotechnic composition but different physical forms. The pressurized gas 127 is in fluid communication with both the booster combustion chamber 113 and the main combustion chamber 119 prior to deploying the initiator 108. Step 134 comprises sending a signal to the initiator 108 to deploy the initiator 108 into the booster combustion chamber 113 to ignite the pyrotechnic booster gas generant 111.

In some implementations of the method, the pyrotechnic booster gas generant 111 comprises the physical form of granules, the pyrotechnic main gas generant 118 comprises the physical form of tablets, and the pressurized gas 127 comprises a mixture of argon and helium. In some implementations, the mixture of argon and helium comprises 95% or more of argon by mole ratio and 5% or less helium by mole ratio. In some implementations, the pressurized gas 127 is pressurized to a range of 4500 to 5500 psi. In some implementations, the pressurized gas 127 is pressurized to a range of 4750 to 5250 psi. In some implementations, the pressurized gas 127 is pressurized to a range of 4900-5100 psi. In one specific example, the pressurized gas 127 is pressurized to a target pressure of 5000 psi (i.e., due to tolerances, some plus/minus range around the target is unavoidable).

What is claimed is:

1. A hybrid airbag inflator comprising:
a pyrotechnic booster gas generant disposed in a booster combustion chamber;
a pyrotechnic main gas generant disposed in a main combustion chamber;
an initiator; and
a pressurized gas;
wherein the pyrotechnic booster gas generant and the pyrotechnic main gas generant comprise the same pyrotechnic composition but different physical forms;
wherein the initiator deploys into the booster combustion chamber to ignite the pyrotechnic booster gas generant; and
wherein the pressurized gas is in fluid communication with both the booster combustion chamber and the main combustion chamber prior to deploying the initiator.

2. The hybrid airbag inflator of claim 1, wherein the pyrotechnic booster gas generant comprises the physical form of granules.

3. The hybrid airbag inflator of claim 2, wherein the granules comprise granules larger than a U.S. #60 sieve size and smaller than a U.S. #4 sieve size.

4. The hybrid airbag inflator of claim 3, wherein the granules comprise granules larger than a U.S. #40 sieve size and smaller than a U.S. #6 sieve size.

5. The hybrid airbag inflator of claim 4, wherein the granules comprise granules larger than a U.S. #20 sieve size and smaller than a U.S. #8 sieve size.

6. The hybrid airbag inflator of claim 2, wherein the pyrotechnic main gas generant comprises the physical form of tablets.

7. The hybrid airbag inflator of claim 1, wherein the pressurized gas comprises a mixture of argon and helium.

8. The hybrid airbag inflator of claim 7, wherein the mixture of argon and helium comprises 80% or more of argon by mole ratio and 20% or less helium by mole ratio.

9. The hybrid airbag inflator of claim 7, wherein the mixture of argon and helium comprises 95% or more of argon by mole ratio and 5% or less helium by mole ratio.

10. The hybrid airbag inflator of claim 1, wherein the pressurized gas is pressurized to a range of 4500 to 5500 psi.

11. The hybrid airbag inflator of claim 10, wherein the pressurized gas is pressurized to a range of 4750 to 5250 psi.

12. The hybrid airbag inflator of claim 11, wherein the pressurized gas is pressurized to a range of 4900-5100 psi.

13. A method of reducing an output of a hybrid airbag inflator comprising:
installing, into a vehicle, a hybrid airbag inflator comprising:
a pyrotechnic booster gas generant disposed in a booster combustion chamber;
a pyrotechnic main gas generant disposed in a main combustion chamber;
an initiator; and
a pressurized gas;
wherein the pyrotechnic booster gas generant and the pyrotechnic main gas generant comprise the same pyrotechnic composition but different physical forms;
wherein the pressurized gas is in fluid communication with both the booster combustion chamber and the main combustion chamber prior to deploying the initiator; and
sending a signal to the initiator to deploy the initiator into the booster combustion chamber to ignite the pyrotechnic booster gas generant.

14. The method of claim 13, wherein the pyrotechnic booster gas generant comprises the physical form of granules.

15. The method of claim 14, wherein the pyrotechnic main gas generant comprises the physical form of tablets.

16. The method of claim 13, wherein the pressurized gas comprises a mixture of argon and helium.

17. The method of claim 16, wherein the mixture of argon and helium comprises 95% or more of argon by mole ratio and 5% or less helium by mole ratio.

18. The method of claim 13, wherein the pressurized gas is pressurized to a range of 4500 to 5500 psi.

19. The method of claim 18, wherein the pressurized gas is pressurized to a range of 4750 to 5250 psi.

20. The method of claim 19, wherein the pressurized gas is pressurized to a range of 4900-5100 psi.
